(19) United States
(12) Patent Application Publication
(10) Pub. No.: US 2006/0061790 A1
(43) Pub. Date: Mar. 23, 2006

(54) Image forming method and apparatus

(75) Inventors: Kazuhiko Miura, Ebina-shi (JP); Ryo Agehama, Ebina-shi (JP); Kazunori Kurokawa, Ebina-shi (JP); Yasushi Nishide, Ebina-shi (JP); Satoshi Yoshikawa, Ebina-shi (JP); Masao Seki, Ebina-shi (JP); Yasuaki Mitobe, Ebina-shi (JP); Yoshiharu Hibi, Ebina-shi (JP); Ryuichi Ishizuka, Ebina-shi (JP); Mari Kodama, Ebina-shi (JP); Toshifumi Takahira, Ebina-shi (JP); Masaomi Sakamoto, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/034,064

(22) Filed: Jan. 13, 2005

(30) Foreign Application Priority Data
Sep. 22, 2004 (JP) 2004-274917

(51) Int. Cl. G06F 3/12

(52) U.S. Cl. 358/1.13

(57) ABSTRACT

In an image forming method and apparatus, a starting point location is acquired for carrying out rasterization of a subfile by interpreting a page descriptive language in the subfile, which is contained in a page print information file, and region size information for forming an image is also acquired from the subfile. Further, any non-interpretable description in the subfile is detected, and when a non-interpretable description is detected in the subfile, a predetermined image is formed at a predetermined position specified by either the starting point location or the starting point location and the region size information.

### CROSS-REFERENCE TO RELATED APPLICATION

This application claims priority under 35 USC 119 from Japanese Patent Application No. 2004-274917, the disclosure of which is incorporated by reference herein.

### BACKGROUND OF THE INVENTION

1. Field of the Invention

The present invention relates to an image forming method and apparatus. More particularly, the present invention pertains to a method and an apparatus for forming an image on a recording paper or the like in accordance with a print job described in a page descriptive language.

2. Description of the Related Art

Desktop publishing (DTP) has become widespread as a result of the digitalization trend in the field of print processing. With DTP, a page layout is configured by carrying out creation, manipulation and edition of an image on processing equipment such as a personal computer or a work station, and based on such a page layout, a film for exposing a printing plate is made (CEPS) or a press plate for printing purposes is made by directly writing on a printing plate (CTP: Computer to Plate).

On the other hand, when a proofreading operation is to be performed prior to a printing operation using an actual press plate, a page layout displayed on a monitor is printed as output (comprehensive layout output), using a WYSIWYG function or the like, by means of a print output apparatus such as a laser printer.

The page layout is configured using a page descriptive language (PDL) such as PostScript. When the page layout is printed as output by means of a print output apparatus, raster data broken down into printing dots are generated by carrying out an RIP process, and a printing process is carried out based on the raster data.

Meanwhile, if an error is present in the data described in the PDL, then appropriate data conversion is difficult to achieve, and a print error will occur.

It is known to provide a printing apparatus which is arranged such that if invalid print information is detected by comparing pre-stored judgment information with print information, this will be notified to a host computer to prevent a print defect from being.

Further, it is known to specify any abnormal file by determining whether a script interpretation is possible for each file when a page consists of plural files.

Font data is stored in a printer or print server wherein a printing process is carried out based on a page layout, which font data is used when carrying out an RIP process. Font data is also stored in a setter such as a film setter for forming a film to make a press plate based on a page layout, or a plate setter for directly exposing a printing plate based on a page layout, which font data is used when carrying out an RIP process or the like.

However, unless the font used in the page layout is stored in the printer or print server, a comprehensive layout output will be produced without the corresponding font being formed, so that an accurate proofreading operation will be unfeasible.

It is known to provide a printer apparatus wherein font information obtained from an analysis of print information and pre-stored font information are compared, and if a discrepancy exists therebetween, this will be notified.

However, in known technology, an error code is simply outputted, and the location of an error in an image on an object is unclear, so that a longer time is required to correct the error.

In order to remove such an error, it is necessary to infer the error portion based on a file name or an error code which is used only internally in the printer or to use an application to correct image data on a trial-and-error basis, which requires a time-consuming and painstaking operation.

Further, when a comprehensive layout is outputted, it is possible that even with a font that can be appropriately formed, if font data concerning the font is not stored in the setter, print defects may occur to the effect that no text in the font concerned will appear on the printed matter.

### SUMMARY OF THE INVENTION

The present invention has been devised in view of the above circumstances. Thus, the present invention proposes an image forming method and apparatus for enabling an appropriate proofreading operation to be performed with respect to a print page described in a page descriptive language.

According to a first aspect of the present invention, an image forming method for generating raster data based on a print page described in a page descriptive language and containing a subfile and for forming an image is provided, the method comprising: acquiring a starting point location for carrying out rasterization of the subfile by interpreting the page descriptive language in the subfile; acquiring region size information for forming an image in the subfile; detecting non-interpretable description in the subfile; and forming a predetermined image at a predetermined position specified by either the starting point location or the starting point location and the region size information when a non-interpretable description is detected in the subfile.

According to a second aspect of the present invention, an image forming apparatus for generating raster data based on a print page described in a page descriptive language and containing a subfile and for executing a printing process based on the raster data is provided, the apparatus comprising: an interpreting unit that interprets page descriptive language in the subfile; a rasterizing unit that generates raster data based on interpretation of the page descriptive language by the interpreting unit; an acquiring unit that acquires either a starting point location or the starting point location and region size information when rasterizing the subfile; and an extracting unit that extracts the subfile when description that cannot be interpreted by the interpreting unit is included therein; wherein a position of an image formed by the subfile extracted by the extracting unit is specified based on either the starting point location or the starting point location and the region size information, and a warning image is formed at the specified position.

According to a third aspect of the present invention, an image forming method for generating raster data based on a print page described in a page descriptive language and for forming an image based on the raster data is provided, the method comprising: forming an image using font data for a font of a character or characters described in the page descriptive language when the font data is stored; substituting the font, when the font data is not stored, with a font for which font data is stored; and generating raster data including an image capable of specifying the substituted font and indicating that the font has been substituted.

According to a fourth aspect of the present invention, an image forming apparatus for generating raster data based on a print page described in a page descriptive language and for executing a printing process based on the raster data is provided, the apparatus comprising: a font extracting unit that extracts a font of a character or characters described in the page descriptive language; a memory that stores font data for fonts which can be printed as output; and a substituting unit that substitutes the font extracted by the font extracting unit, when data for the font is not stored in the memory, with a font for which font data is stored in the memory; wherein raster data is generated which includes a character or characters in the font newly substituted by the substituting unit and an image capable of specifying the character or characters, thereby carrying out a process for forming an image based on the print job.

Other features and advantages of the present invention will become apparent to one of ordinary skill in the art from the ensuing description taken in conjunction with the accompanying drawings.

### BRIEF DESCRIPTION OF THE DRAWINGS

Embodiments of the present invention will be described in detail based on the following figures, wherein:

FIG. 1 is a schematic block diagram illustrating an image forming system applied to an embodiment of the present invention;

FIG. 2 is a flowchart outlining a rasterizing process in a print server;

FIG. 3 is a flowchart outlining a rasterizing process;

FIG. 4 is a flowchart outlining extraction of a script error from a subfile;

FIG. 5A illustrates character strings representing the main portions of a description in a page print information file;

FIG. 5B is a schematic view illustrating a hypothetical print output corresponding to the description shown in FIG. 5A;

FIG. 5C is a table showing an example of information stored in a memory;

FIG. 6A is a schematic view illustrating a print output produced when a starting point location and region size information have been acquired from a subfile in which a script error is present;

FIG. 6B is a schematic view illustrating a print output produced when a starting point location has been acquired from a subfile in which a script error is present;

FIG. 7A is a schematic view illustrating an example of a print output for a case where no font error has occurred;

FIGS. 7B through 7D illustrate examples of print outputs respectively corresponding to cases where font errors have occurred.

### DETAILED DESCRIPTION OF THE INVENTION

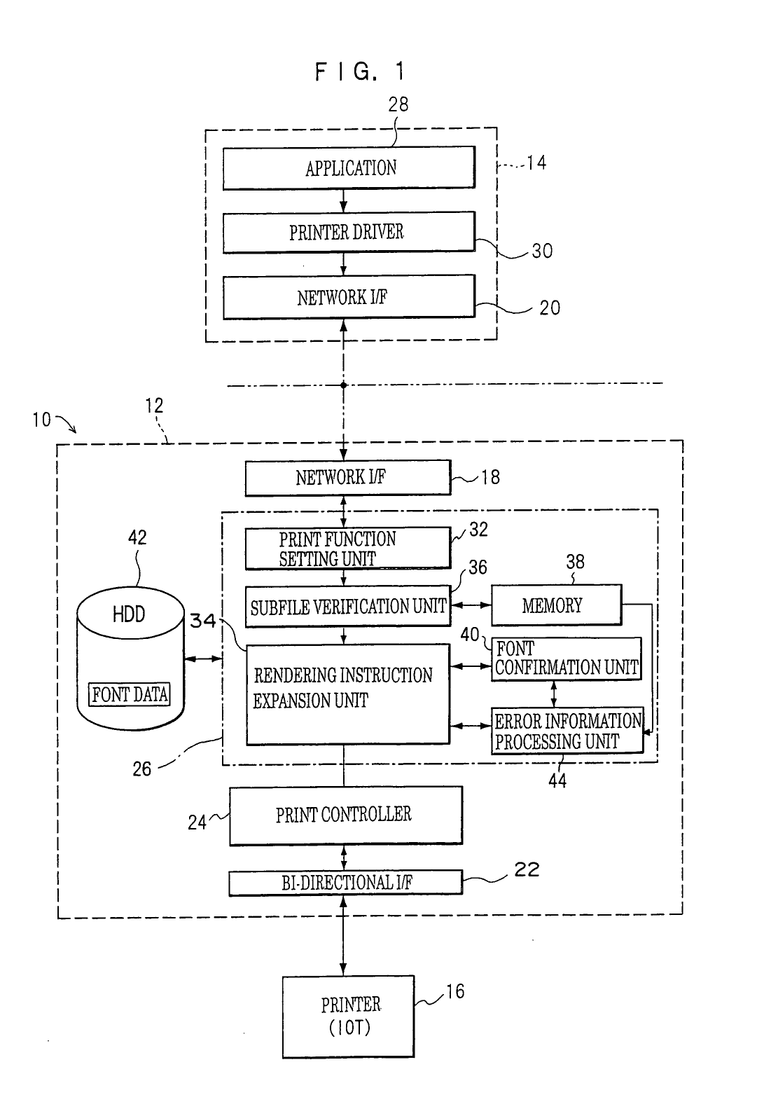

An embodiment of the present invention will now be described with reference to the drawings. FIG. 1 schematically illustrates the structure of an image forming system 10 as applied to the embodiment, wherein a print server 12 provided as an image processing unit, and multiple client personal computers 14 provided as image processing terminals using personal computers or the like, are connected to a network

Further, a printer 16 is connected to the print server 12 as a print output device (IOT). On receiving a print job output from one of the client personal computers 14, the print server 12 performs a print process based on the print job, thereby providing a print output corresponding to the print job.

The printer 16 may comprise a copying machine equipped with an image reading function or a composite machine combining the functions of a print output device and a copying machine. The network within which the image forming system 10 is provided may be arranged such that, for example, a plate setter for directly exposing a photosensitive flat printing plate based on image data in order to produce a press plate for printing purposes, or a film setter for exposing a manuscript film to be used for image-printing (exposing) with respect to a photosensitive flat printing plate, is connected thereto.

The print server 12 and each of the client personal computers 14 respectively include network interfaces 18 and 20 and are connected to each other through these interfaces. The print server 12 further includes a bidirectional interface (bidirectional IF) 22 through which it is connected to the printer 16. Furthermore, a plurality of printers 16 may be connected to the print server 12.

The print server 12 can be constructed by adding a PCI board having the requisite functions to a personal computer (PC). Further, the print server 12 may include input units such as a keyboard and a mouse, and a display unit such as a CRT display or an LCD display. The print server 12 may also be equipped with a WYSIWYG function so that an image displayed on the display unit may be processed and the displayed image printed as output.

The print server 12 includes a print controller 24 for controlling the printer 16, and an image processing section 26. The image processing section 26 performs an image processing operation in response to the print job inputted thereto from one of the client personal computers 14 and generates raster data through an RIP process.

In the print server 12, the inputted print job is stored in a process wait queue; the print job stored in the process wait queue is sequentially read out to perform an image process (RIP process); and image-processed data (raster data) to be outputted to the printer 16 is stored in a print wait queue which in turn sequentially provides an output to the printer 16. Further, the print server 12 is configured such that a job for which no print process is specified or for which a specified print process cannot be performed is stored and held in a hold queue. The print server 12 may use any of a variety of conventional configurations, and further detailed description thereof is omitted with respect this embodiment.

Moreover, each of the client personal computers 14 is provided with an application 28, which is used for image processing and document production, namely, creation, manipulation and editing of images or text. The application can also be used to create documents for page layout and the like to be used in press plates for printing. In the client personal computers 14, page layout documents and the like are made using a predetermined page descriptive language such as PostScript or the like.

The client personal computers 14 are further each provided with a printer driver (driver software) 30 so that a variety of processing instructions such as print functions can be set using the printer driver, thereby enabling a page layout configured using the application 28 to be transmitted to the print server 12 as a print job

The image processing section 26 of the print server 12 includes a print function setting unit 32. Accordingly, the print server 12 is arranged such that conventional print functions can be set. Further, print functions specified by a print job are determined in the print function setting unit 32, and set up so as to be performed at the print controller 24 and image processing section 26. Meanwhile, conventional means may be employed for the purposes of setting and performing the print functions, and detailed description thereof is omitted with respect to this embodiment.

Further, the image processing section 26 of the print server 12 includes a rendering instruction expansion unit 34 which performs an RIP process on a page unit basis for a print job document. The application 28 provided in the client personal computers 14 forms a document using a predetermined page descriptive language (PDL), and the rendering instruction expansion unit 34 interprets a description in the page descriptive language and expands it as raster data.

Moreover, in the printer server 12, the image processing section 26 includes a subfile verification unit 36 and a memory 38. In a print job document, each page consists of a page print information file and a subfile such as an EPS file formed using PostScript.

The subfile verification unit 36 extracts a subfile and determines, from the script of the subfile, a starting point location and the region size of a region defined by the script during a rasterizing operation, and then stores the starting point location and region size in the memory 38. When interpretation of the script of the subfile cannot be successfully completed, the starting point location and region size of the pertinent subfile, which are stored in the memory 38, are stored as error log data.

When an error occurs in the script representing the size information, the region indicated in the pertinent subfile is unknown, and in such a case, only the starting point location is stored as error log data.

In this manner, the print server 12 can identify the subfile in which a script error has occurred from the error log data.

The image processing section 26 further includes a font confirmation unit 40, and the print server 12 includes a hard disc drive (HDD) 42 which is used to store a variety of data and, for example, print jobs held in a process wait cue.

Font data are stored in the HDD 42 for font that can be used at the image forming system 10, as well as font data that can be used at a setter (not shown) for forming an image on a print plate or a film to be used for exposing the print plate based on a page layout made at the client personal computers 14.

The font confirmation unit 40 confirms whether the font is a font usable in the image forming system 10 or a font usable at the setter (not shown), by collating the font used at the print job with the font data stored in the HDD 42.

Additionally, the image processing section 26 includes an error information processing unit 44, wherein when a font not registered in the print server 12 is used at the font confirmation unit 40, the font is replaced with a predetermined font.

When a font unregistered with the print server 12 or a font unusable at the setter (not shown) is detected, the description of the font is clarified, and it is clearly indicated that that font is unregistered.

On the basis of error log data generated because of a script error occurring in a subfile, the error information processing unit 44 performs a given image transformation process or image formation process so as to ensure that the pertinent subfile is clearly specified in the print output.

The rendering instruction expansion unit 34 carries out rasterization including that of information defined at the error information processing unit 44.

In the image forming system 10 structured as described above, a document such as a page layout, which has been subjected to processes such as creation, manipulation and editing using the application 28 at one of the client personal computers 14, is formed in a predetermined page descriptive language; the document is transmitted to the print server 12 as a print job; and a printing process is performed upon receipt of the print job.

In the printing process in the print server 12, first of all, the print functions are read in and set at the print function setting unit 32, and an RIP process (rasterization) is performed on a page unit basis in accordance with the print job at the rendering instruction expansion unit 34, as a result of which raster data are generated.

The print controller 24 outputs raster data to the printer 16 as print data at a given timing, and the printer 16 performs a printing process based on the print data, thereby providing a print output according to the print job.

The print server 12 is arranged so as to detect whether or not an error occurs in print data described using a PDL and to clearly indicate the error position should an error be detected. The print server 12 is further arranged so as to confirm whether or not the font used in the print job is a font registered in the print server 12 and stored in the HDD 42 and whether or not the font is usable at the setter (not shown). When a font not registered in the print server 12 is used (font which has not become usable), the font is substituted with another font, and when a font unusable in the setter is detected, it is clearly indicated in the print output that the font in question is unusable at the setter. Hereinafter, the error process is taken to include these processes.

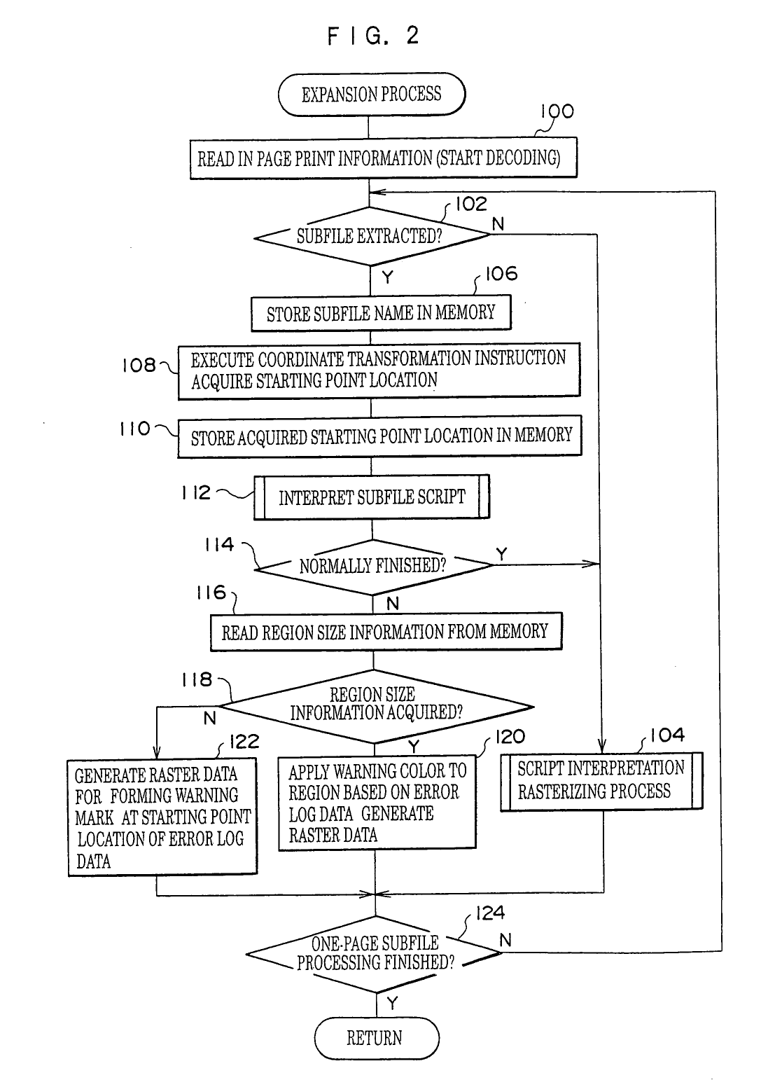

With reference to FIGS. 2 through 7, description will now be made of the error process which is performed in the print server 12.

In the image processing section 26 of the print server 12, when a print function corresponding to the print job is set by the print function setting unit 32, raster data is generated on a pageby-page basis at the rendering instruction expansion unit 34. Prior to this, verification of a subfile is carried out by the subfile verification unit 36.

At the font confirmation unit 40, confirmation of the font in use is made prior to rasterization.

The process illustrated by the flowchart in FIG. 2 is executed when, after the print functions have been set up, rasterization is carried out on a page unit basis, wherein at an initial step 100, a page print information file of a page to be processed is read out and begins to be decoded.

At a next step 102, confirmation is made as to whether the subfile has been extracted. At this time, if no subfile has been extracted, then a negative confirmation is made at the step 102, and the operation advances to a step 104, where the script is interpreted, and rasterization is carried out based on the interpretation.

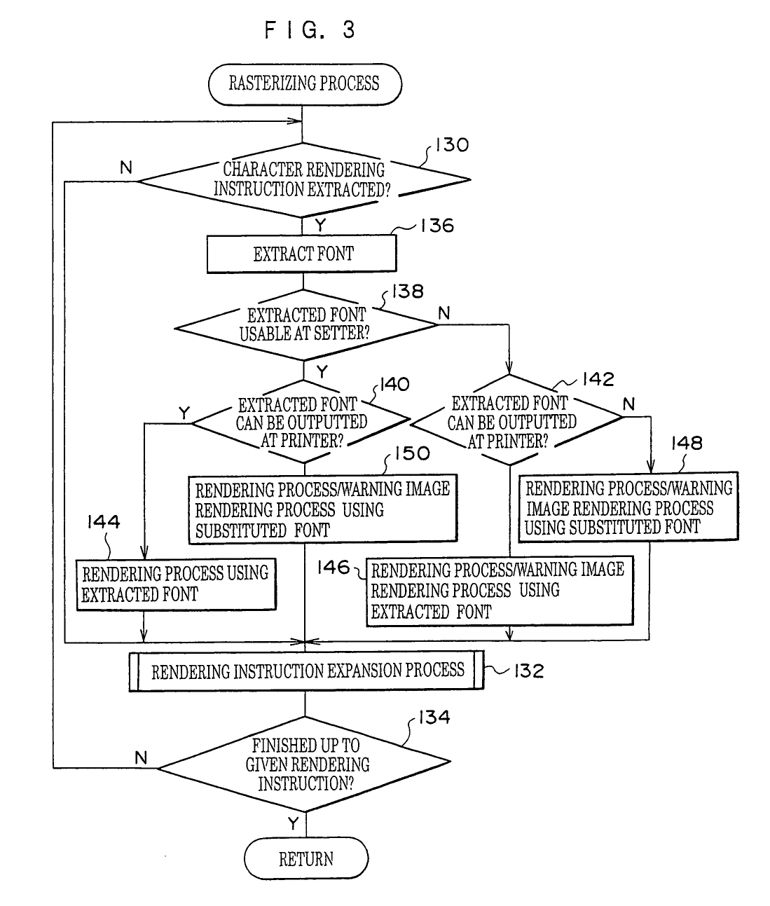

FIG. 3 outlines the process performed at such an occasion. As shown in the flowchart, when script interpretation is conducted sequentially, confirmation is made at a first step 130 as to whether a character rendering instruction has been provided. In the absence of such instruction, a negative decision is taken at the step 130 and the operation advances to a step 132, where rasterization (a rendering instruction expansion process) based on the pertinent rendering instruction is executed. At a step 134, confirmation is made as to whether the rasterization based on the script interpretation up to a given region and on the rendering instruction has been completed, and if not, the operation returns to the step 130, where a subsequent script interpretation is performed.

If a character rendering instruction is detected, then a positive confirmation is made at the step 130, and the operation advances to a step 136, where a font is extracted from the rendering instruction. Subsequently, at a step 138, a confirmation is made as to whether the extracted font is usable at the setter. Then, at steps 140 and 142 respectively, a confirmation is made as to whether the extracted font is usable in the print server 12 (printer 16). This decision is taken by comparing the extracted font with the fonts usable at the setter that are stored in the HDD 42.

If the extracted font is a font which can be used at the setter and can be printed as output at the printer 16, then a positive judgment is made at each of the steps 138 and 140, and the operation advances to a step 144.

At the step 144, rasterization is carried out using the extracted font and based on the rendering instruction.

If it is judged that the extracted font is a font which can be printed as output at the printer 16 but is unusable at the setter, then a negative judgment is made at the step 138 while a positive judgment is made at the step 142.

As a result, the operation advances to a step 146, where rasterization is executed using the extracted font and based on the rendering instruction in such a manner that a warning process indicating that the extracted font is unusable at the setter is applied to the region in which the extracted font is used.

In contrast, if the extracted font is a font which cannot be printed as output at the printer and is unusable at the setter, then a negative judgment is made at each of the steps 138 and 140, and the operation advances to a step 148.

At the step 148, the extracted font is substituted with a font usable at the printer 16, and rasterization based on the rendering instruction is carried out in such a manner that the region using the extracted font is defined by the substituted font and a warning process is applied which indicates that the original font is a font unusable at the setter.

Further, if the extracted font is a font which cannot be printed as output at the printer 16 and is usable at the setter, then a positive judgment is made at the step 138 while a negative judgment is made at the step 140, and as a result the operation advances to a step 150.

At the step 150, the extracted font is substituted with a font usable at the printer, and rasterization based on the rendering instruction is executed in such a manner that a warning process is applied which indicates that the region using the extracted font is defined by the substituted font and that the original font is a font usable at the setter.

In the flowchart illustrated in FIG. 2, when a subfile is extracted, a positive judgment is made at a step 102, and the operation advances to a step 106, where the subfile name is stored in a title memory (a region secured in the memory 38). Any suitable conventional means may be utilized to acquire the subfile name.

At a step 108, the starting point location of the subfile is acquired by executing a coordinate transformation instruction, and the starting point location thus acquired is stored in a region secured in the memory 38 (step 110).

Subsequently, a script interpretation process for the subfile is carried out at a step 112.

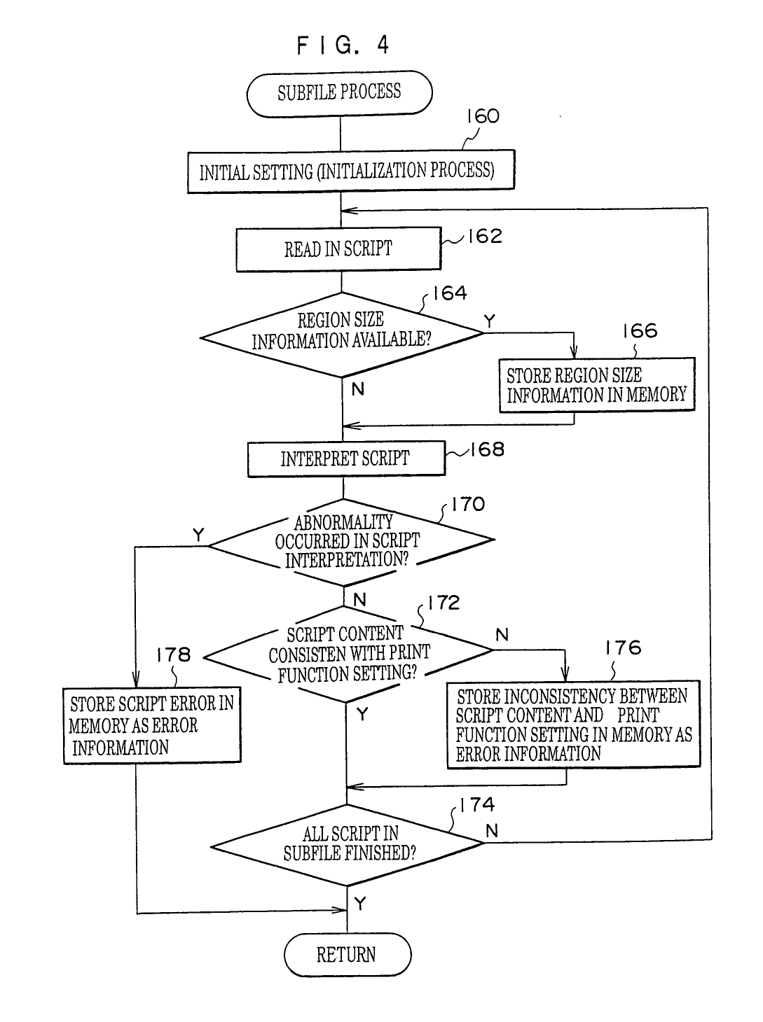

FIG. 4 illustrates a flowchart outlining the script interpretation process for each subfile which is carried out at the step 110 in FIG. 2.

According to the flowchart shown in FIG. 4, an initialization process is carried out at a first step 160, the script of each subfile is read in at a subsequent step 162, and a confirmation is made at a step 164 as to whether the script as read in consists of region size information for an image described by the subfile.

If the script does consist of such region size information, then positive confirmation is made at the step 164, and the operation advances to a step 166 where the region size information is stored in a region size information memory which is secured in the memory 38.

Subsequently, the script as read in is subjected to script interpretation at a step 168, and confirmation is made at a step 170 as to whether any abnormality has occurred in the script interpretation.

If no abnormality has occurred, then the confirmation made at the step 170 is negative, and the operation advances to a step 172, where a confirmation is made as to whether the content of the script interpretation is consistent with the setting of the print functions. If consistent, the confirmation made at the step 172 is positive, and the operation advances to a step 174, where confirmation is made as to whether interpretation has been completed with respect to all the scripts of the subfile. If any script remains to be interpreted, then the confirmation made at the step 174 is negative, and the operation returns to the step 162, where the process for the next script will be initiated.

If, for example, the script interpreted is in an RGB format despite the fact that YMCK color correction is required the confirmation made at the step 172 is negative, and the operation advances to a step 176.

At the step 176, error information indicating that the content of the script interpretation is inconsistent with the setting of the print functions is stored in a region which is secured in the memory 38.

In contrast, if any abnormality has occurred in the script interpretation, the confirmation made at the step 170 is positive, and the operation advances to a step 178, where error information indicating that a script error has occurred is stored in a error information memory which is secured in the memory 38. In this manner, the process for this subfile is completed.

According to the flowchart shown in FIG. 2, when the script interpretation for the subfile is finished, a confirmation is made at a step 114 as to whether the script interpretation process for the subfile is normally finished, i.e., confirmation that no error information is stored in the memory.

If no error exists in the subfile, and if the process for the script in the subfile is normally finished, the confirmation made at the step 114 is positive, and the operation moves to a step 104, where script interpretation and a rasterization process are carried out. In such a case, since script interpretation has already been completed in a previous step, it is also possible that the process may be carried out based on the interpretation of the already interpreted script.

In contrast, if the interpretation of the script in the subfile is not finished normally and error information is stored in the memory, then the confirmation made at the step 114 is negative, and the operation advances to a step 116 where size information in the subfile concerning the region which is intended to be printed is read out of the region size information memory. At a step 118, confirmation is made as to whether the region size information was correctly read out of the memory 38.

If the region size information is read out correctly, the confirmation made at the step 118 is positive and the operation advances to a step 120 where, from error log data of the subfile including the region size information and starting point location, raster data is generated to apply a warning color to the rendering region of the subfile based on the starting point location and region size information.

In a case where error information is defined by a mismatch (disagreement) of the script to the print setting instead of by a script error, an error process is performed with respect to the print setting mode preset in the print server 12.

In contrast, if the region size information was not acquired correctly then the confirmation made at the step 118 is negative, and the operation advances to a step 122 where raster data is generated so as to permit a pre-set warning mark to be formed at the starting point location stored in the memory 38.

When the process for one page is finished in this manner, the process for a next page is commenced while the print data concerning the processed page is outputted to the printer 16 and a printing process is executed.

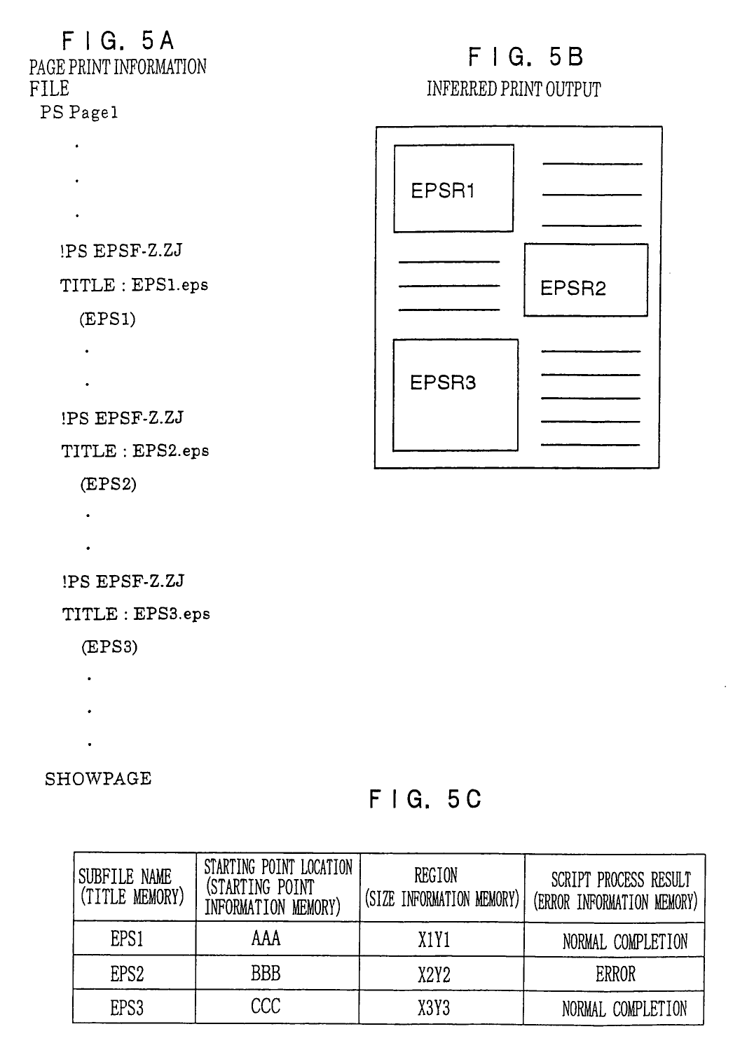

For the description of a page print information file as illustrated in FIG. 5A, for example, a print output such as illustrated in FIG. 5B is conceivable, which may also be taken to correspond to a display on the monitor of one of the client personal computers 14.

In the description of the page print information file illustrated in FIG. 5A, (ESP1), (ESP2), and (ESP3) respectively represent subfiles, and images rendered by the respective subfiles are indicated at EPSR1, EPSR2, and EPSR3 in FIG. 5B respectively.

If it is assumed that a script error occurs only at the subfile ESR2, then data such as is shown in FIG. 5C will be stored in the memory 38.

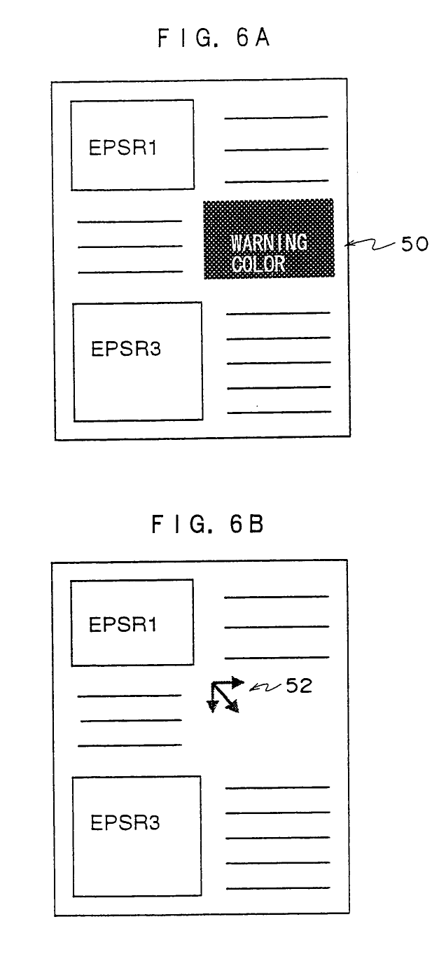

In such a case, if it is also assumed that a script error occurs when the starting point location and region size information are acquired appropriately, a warning color is applied to the whole of the region on the print output defined by the starting point location and region size information, as illustrated in FIG. 6A (the process at step 120 in FIG. 2).

In this manner, it is possible to accurately specify the occurrence of a script error as well as the subfile in which the script error has occurred.

In a case where an error has occurred in the subfile ESP2, for example, such that the starting point location can be specified while region size information cannot be acquired, a warning mark 52 is indicated at the starting point location as shown in FIG. 6B (the process at step 112 in FIG. 2).

Consequently, the subfile in which an error has occurred in the description written in a page descriptive language can be easily identified, and an accurate response to the error can be effectively provided, thus resulting in enhanced efficiency of the proofreading operation.

Although in the above-described embodiment, a clear indication of a script error was provided using the warning image 50 or warning mark 52 having the warning color applied thereto, it is possible that in the case of black-and-white print, for example, printing may be performed according to a preset warning pattern

It is also possible that an error code or modification example may be printed, using error log data, in the region concerned, based on information identifying the subfile in which a script error has occurred (identifying information), the starting point location, and region size information.

Further, it is possible that the page and/or print job in which a script error has occurred may be transmitted in a data form such as TIFF format, instead of being printed as output, to the client personal computer 14 which outputted the print job concerned. Yet further, it is also possible that such a page and/or print job may be displayed as a preview image on a monitor (display device) provided in the print server 12, when the preflight function for acquiring information such as errors is implemented by conducting rasterization.

Furthermore, when plural copies of print output are specified, it is possible that only one copy including the page in which a script error has occurred may be printed as output. It is also possible to preset such that one copy of only the page in which a script error has occurred may be printed as output

The print server 12 is arranged such that font errors are detected together with script errors, and when a font error occurs, the font error is also clearly indicated.

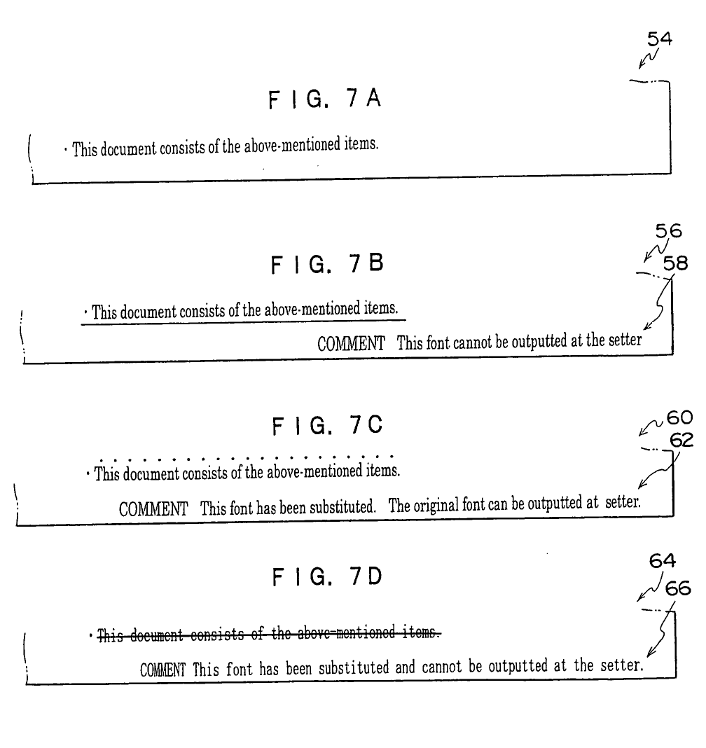

In the case of, for example, a print output 54 such as illustrated in FIG. 7A, if the font can be printed as output at the printer 16 and is usable at the setter, the font will be subjected to a printing process as it is (the print output 54 is obtained).

In contrast, in the case of a font which can be printed as output at the printer 16 but is unusable at the setter, a print output 56 shown in FIG. 7B will be obtained. The print output 56 specifically indicates the font which is unusable at the setter and also clearly indicates in a comment 58 that the font used is unusable at the setter (the process at the step 146 in FIG. 6). In FIG. 7B, the font is clearly specified by being underlined

In the case of a font which cannot be printed as output at the printer 16 but is usable at the setter, a print output 60 shown in FIG. 7C will be obtained. In the print output 60, since the font is one which cannot be outputted at the printer 16, the font is substituted with a font which can be outputted at the printer, the substituted font is indicated, and in a comment 62, it is clearly indicated that the font is one which cannot be outputted at the printer but is usable at the setter (the process at the step 150). Here, by way of example, the font substituted is indicated by dots.

Further, when use is made of a font which cannot be printed as output at the printer 16 and is unusable at the setter, a print output 64 such as shown in FIG. 7D is obtained. In the print output 64, since the font is one which cannot be outputted at the printer 16, the font is substituted with a font which can be outputted at the printer, the substituted font is indicated, and in a comment 66, it is clearly indicated that the font is one which cannot be outputted at the printer and is unusable at the setter (the process at the step 148 in FIG. 3). Here, by way of example, the font is indicated with a double strike-through line.

As will be appreciated, the print server 12 is arranged so that even if the font of a character used in a document (page layout) for a print job is a font which cannot be outputted at the printer 16, a described sentence is clarified through a substitution of the font with a font which can be outputted at the printer, thereby making it possible to proofread the sentence.

Further, in addition to whether the font in use is usable at the printer, it is also possible to determine whether the font is usable at the setter by, for example, storing in the memory a font which can be used at the setter.

By so doing, it is possible to reliably prevent occurrence of defects such as character omission, which tends to be caused when a printing plate is made or a film is exposed to make a printing plate without noticing that the font in use is a font unusable at the setter.

Although in this embodiment a font error is indicated by underlining, dots, or double strike-through lines, it is to be understood that the indication method is by no means limited thereto, and it is also possible that other indication methods such as outline characters or half-tone dot meshing may be employed. Further, for color printing, the error may be indicated in a color different from the original color. In addition, a comment may be described with agate applied to the font concerned.

Still further, it is also possible that a warning page may be provided in the form of a speech balloon containing character(s) or sentence(s) using the font concerned, which may be printed as output together with the warning content.

Furthermore, although in this embodiment a specific warning content is described as a comment, it is also possible that describing such specific warning content as a comment may be omitted by pre-setting a combination of a clear indication of font error and warning content.

The name of the original font and the name of the substituted font may be included with respect to the error font.

As will be appreciated from the above discussion, according to the present invention, a page described in a page descriptive language includes page print information and a subfile or subfiles contained in a page print information file, and since a script error occurs when any abnormality exists in a description in a subfile, a judgment is made as to whether the description in the subfile is interpreted appropriately.

Further, since the description in the subfile includes a starting point location for forming an image on a print page based on the description in the subfile, either the starting point location or the starting point location and region size information are acquired, and a warning image is formed at a position specified by either the starting point location or the starting point location and region size information.

By so doing, it is possible to identify an image which has caused a script error on a certain page from the position of the warning image, thus greatly facilitating correction of the script error.

In the present invention, the above-mentioned warning image can be formed as a warning mark defined at the above-described starting point location.

Thus, even if an error occurs in a subfile, the starting point location can at least be specified so that the warning mark may be formed at the starting point location.

Further, it is also possible that the above-mentioned warning image may be formed by applying a warning color to a region defined by the starting point location and region size information.

Still further, it is also possible that when the subfile is extracted by the extracting unit, the print setting of the above-described print job in which the subfile is contained may be changed.

In this manner, it is possible to prevent waste by, for example, printing only one copy when a print process for multiple copies is implemented.

Furthermore, according to the present invention, when a font is used that cannot be used to form an image, the font is substituted by a font that can be outputted.

Concomitantly, an image is formed which is capable of specifying both the font substitution and the characters formed in the substituted font.

In this manner, when the print job uses a font which cannot be printed as output, it is possible to clearly indicate this font as well as the characters or sentences described in the font concerned.

According to the present invention, it is possible to judge whether a font used is preset and stored in the memory.

Thus, it is possible to judge from a print output whether a font can be used to make a press plate, prior to forming a page layout, making the press plate based on the page layout, and carrying out a printing process.

As described above, according to the present invention, it is possible to easily and appropriately specify, from a print output, a subfile in which a script error occurs, thereby greatly facilitating correction of a page layout or a document.

Further, the present invention is advantageous in that it is possible to clearly determine not only a font which cannot be printed as output together with characters or sentences using the font, but also whether or not a preset font is used.

While the present invention has been illustrated and described with respect to specific embodiments thereof wherein, for example, a determination is made as to whether a font is usable at the setter, it is to be understood that the present invention is not limited thereto. When a font or fonts are registered which are usable not only at a setter but also at other image forming apparatuses, it is also possible to determine whether a font is usable at such image forming apparatuses.

Further, while the present invention has been illustrated and described with respect to the image forming system 10 comprising the print server 12 and printer 16, it is to be noted that the present invention is not limited thereto but is applicable to any type of image forming apparatus.

What is claimed is:

1. An image forming method for generating raster data based on a print page described in a page descriptive language and containing a subfile and for forming an image, the method comprising:
acquiring a starting point location for carrying out rasterization of the subfile by interpreting the page descriptive language in the subfile;
acquiring region size information for forming an image in the subfile; and
detecting non-interpretable description in the subfile; and
forming a predetermined image at a predetermined position specified by either the starting point location or the starting point location and the region size information when a non-interpretable description is detected in the subfile.

2. An image forming apparatus for generating raster data based on a print page described in a page descriptive language and containing a subfile and for executing a printing process based on the raster data, the apparatus comprising:
an interpreting unit that interprets a page descriptive language in the subfile;
a rasterizing unit that generates raster data based on interpretation of the page descriptive language by the interpreting unit;
an acquiring unit that acquires either a starting point location or the starting point location and region size information when rasterizing the subfile; and
an extracting unit that extracts the subfile when description that cannot be interpreted by the interpreting unit is included therein;
wherein a position of an image formed by the subfile extracted by the extracting unit is specified based on either the starting point location or the starting point location and the region size information, and a warning image is formed at the specified position.

3. The image forming apparatus according to claim 2, wherein the warning image is a warning mark formed at the starting point location.

4. The image forming apparatus according to claim 2, wherein the warning image is formed by applying a warning color to a region defined based on the starting point location and the region size information.

5. The image forming apparatus according to claim 2, wherein a print setting of the print job containing the subfile is changed when the subfile is extracted by the extracting unit.

6. The image forming apparatus according to claim 3, wherein a print setting of the print job containing the subfile is changed when the subfile is extracted by the extracting unit.

7. The image forming apparatus according to claim 4, wherein a print setting of the print job containing the subfile is changed when the subfile is extracted by the extracting unit.

8. The image forming apparatus according to claim 2, wherein the warning image is a warning mark formed at the starting point location, the warning image being formed by applying a warning color to a region defined based on the starting point location and the region size information.

9. The image forming apparatus according to claim 8, wherein a print setting of the print job containing the subfile is changed when the subfile is extracted by the extracting unit.

10. An image forming method for generating raster data based on a print page described in a page descriptive language and for forming an image based on the raster data, the method comprising:
forming an image using font data for a font of a character or characters described in the page descriptive language when the font data is stored;
substituting the font, when the font data is not stored, with a font for which font data is stored; and
generating raster data including an image capable of specifying the substituted font and indicating that the font has been substituted.

11. The image forming method according to claim 10, wherein when the font of the character described in the page descriptive language is a preset font, raster data including an image capable of specifying the font and indicating that the font is a preset font is generated.

12. An image forming apparatus for generating raster data based on a print page described in a page descriptive language and for executing a printing process based on the raster data, the apparatus comprising:
a font extracting unit that extracts a font of a character or characters described in the page descriptive language;
a memory that stores font data for fonts which can be printed as output; and
a substituting unit that substitutes the font extracted by the font extracting unit, when data for the font is not stored in the memory, with a font for which font data is stored in the memory;
wherein raster data is generated which includes a character or characters in the font newly substituted by the substituting unit and an image capable of specifying the character or characters, thereby carrying out a process for forming an image based on the print job.

13. The image forming apparatus according to claim 12, wherein a predetermined font is stored in the storing unit; a judgment is made as to whether the font extracted by the font extracting unit is the predetermined font stored in the storing unit; and a result of the judgment is produced together with an image based on the print job.
